(19) United States
(12) Patent Application Publication
(10) Pub. No.: US 2011/0174901 A1
(43) Pub. Date: Jul. 21, 2011

(54) GRAVITY CUP FOR A PAINT SPRAYER

(76) Inventors: Peter Dettlaff, Remseck (DE); Klaus Leipold, Dettenhausen (DE)

(21) Appl. No.: 13/121,531

(22) PCT Filed: Sep. 29, 2009
(86) PCT No.: PCT/EP09/06992

§ 371 Date: Mar. 29, 2011

(30) Foreign Application Priority Data
Oct. 29, 2008 (DE) 20-2008-014-389.6

(51) Int. Cl. B05B 9/00

(52) U.S. Cl. 239/345

(57) ABSTRACT

The invention relates to a gravity cup for a paint sprayer, having a cup-shaped tank (1) and a cover (2) that can be placed on the tank (1), a multiplex quick-connect thread having at least two external thread turns (18) and internal thread turns (19) engaging with the external thread turns (18) for connecting the tank (1) and the cover (2), characterized in that each external thread turn (18) is formed of a plurality of thread segments (18a, 18b, 18j) disposed along the pitch line of each external thread turn, wherein a gap (18p, 18q . . . 18w) is formed between adjacent thread segments.

The invention concerns a gravity cup for a paint sprayer according to the preamble of claim 1.

Traditional gravity cups for paint sprayers usually have a cup-shaped tank, on whose lower side, an opening with a connecting part for the detachable affixing of the tank on the upper side of the paint sprayer is provided. The connecting part usually consists of a connecting piece inserted into the tank bottom, which has an external thread for screwing into a corresponding thread opening on the upper side of the paint sprayer. As a rule, the cup-shaped tank is closed on its upper side by a suitable cover, which is meant to prevent an undesired discharge of the paint.

Gravity cups, which comprise a cup-shaped tank and a cover with a hollow-cylindrical connecting part that can be placed on it, are already known from WO 01/12337 A1, WO2004/037433 A1, EP 1 366 823 A1, and EP 1902786 A1. The connecting part there comprises a connecting piece shaped directly on the tank cover, for a quick connection of the gravity cup to the paint sprayer. With the gravity cup of EP 1902786 A1, furthermore, a quick-connect thread, in the form of a four-turn pitch thread with external thread turns on the upper external circumference of the tank and corresponding internal thread turns on the inside of the cover is provided for the tight connection of the cover with the cup-shaped tank. The four external thread turns on the tank are uniformly distributed over the external circumference of the tank and arranged in such a way that the beginning of the one thread turn is directly over the end of the next thread turn. In this way, the cover can be firmly screwed with the tank by a more or less fourth rotation.

As a result of a nonhomogeneous rigidity of the tank sealing border around the external circumference of the tank, and wall thickness aggregations formed during the injection molding of the tank distributed nonuniformly

over the circumference, the tanks known from the state of the art tend to have leaks, especially with a local deformation if the tank is compressed when it is being manually handled in the upper rim area.

The goal of the invention is to further develop the gravity cups of the types mentioned in the preamble, so that they have an improved tightness between the tank and the cover set on it.

This goal is attained by a gravity cup with the features of claim 1. Appropriate developments and advantageous refinements of the invention comprise the subject of the subclaims.

With the gravity cup in accordance with the invention, which comprises a cup-shaped tank and a cover which can be placed on the tank, a multiplex quick-connect thread with at least two external thread turns and internal thread turns, acting together with the external thread turns, is provided for the connection of the tank and the cover, wherein each external thread turn is formed by a plurality of thread segments located along the slope line of the individual external thread turn. A gap is formed between adjacent thread segments. In this way, wall thickness aggregations that appear in the area of the external thread turns during the injection molding, are largely avoided and the upper rim of the tank has a constant rigidity over the external circumference, which leads to an improved tightness when the cover is screwed on the tank via the quick-connect thread.

The external thread turns are preferably shaped on the upper external circumference of the tank, and the internal thread turns are located on the cover. However, it is also possible to place the external thread turns on the cover and the internal thread turns on the external circumference of the tank. Furthermore, at least one ramp is preferably provided on each external thread turn, which makes possible an improved and especially, a smooth screwing behavior when the cover is screwed on the tank. The guide ramp(s) are appropriately placed on the upper side of each external thread turn, in particular, on the upper side of two adjacent thread segments. In a preferred embodiment, the guide ramps are located between two adjacent thread segments—that is, above the gap—and bridging the two adjacent thread segments.

In a preferred embodiment example, the internal thread turns are located on the inside of a flange on the cover and on the internal circumference of the flange, in the direction of closing of the quick-connect thread, tapering in an axial direction. Upon placing the cover on the tank rim, the guide ramps located on the upper side of each external thread turn act as guide aids and upon screwing the quick-connect thread, the guide ramps mesh into the internal thread turns on the cover and are wedged there as a result of the tapering of the internal thread turn in the closing direction of the quick-connect thread. In this way, a firm seat of the screwed quick-connect thread is guaranteed, which cannot become loosened by itself—for example, because of vibrations during the injection process.

Other special features and advantages of the invention can be deduced from the following description of a preferred embodiment example with the aid of the drawings. The figures show the following:

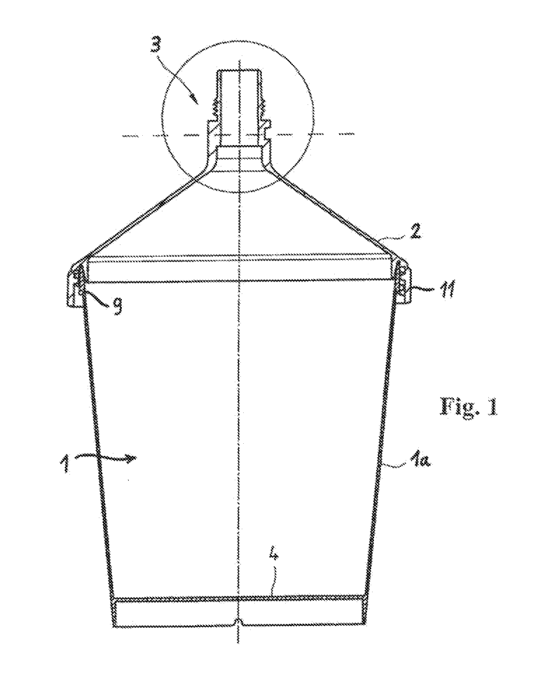

FIG. 1, a gravity cup, in accordance with the invention, with a cup-shaped tank and a cover which is placed on it, in a sectional view;

FIG. 2, a view of the cup-shaped tank and the cover of the gravity cup of FIG. 1 with a quick-connect thread to screw the cover on the tank;

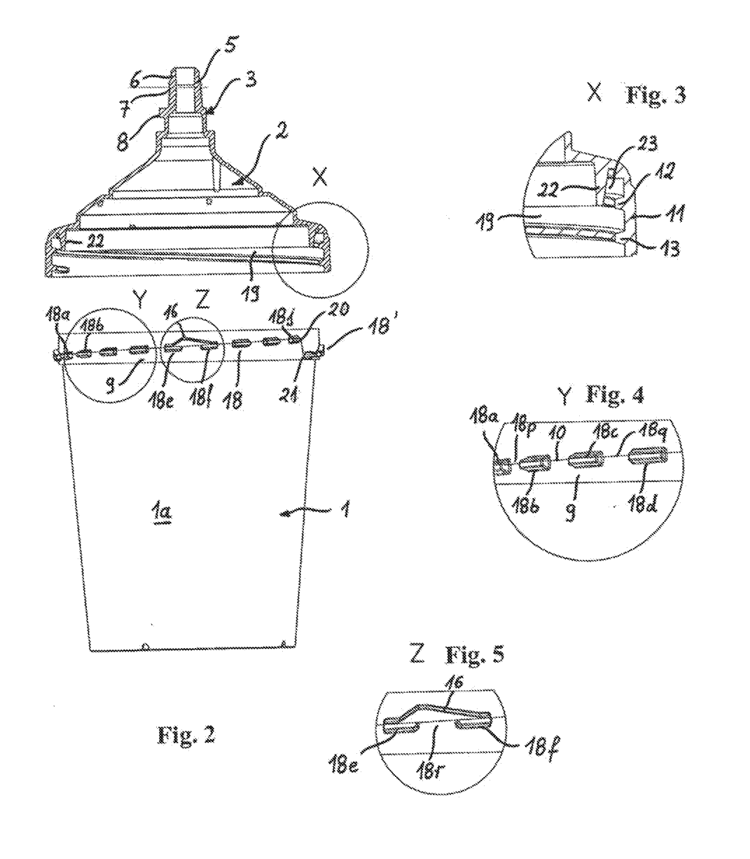

FIG. 3, a detailed view of area X of FIG. 2;

FIG. 4, a detailed view of area Y of FIG. 2; and

FIG. 5, a detailed view of area Z of FIG. 2;

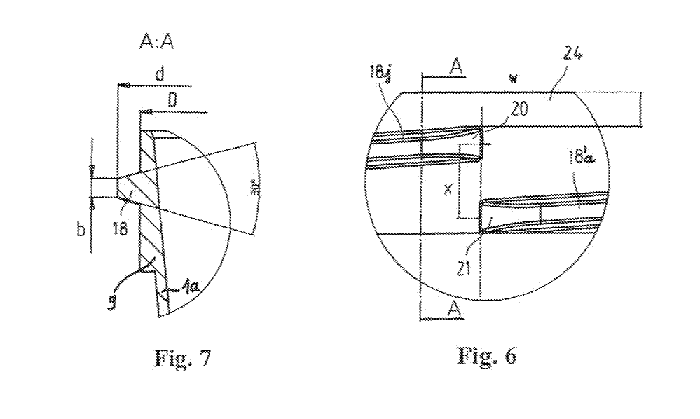

FIG. 6, a detailed view of the transitional area of a thread turn of the quick-connect thread to the next thread turn;

FIG. 7, a sectional view along the line A-A of FIG. 6.

The gravity cup for a paint sprayer, shown in sectional view in FIG. 1, comprises a cup-shaped tank 1 and a cover 2, placed on it, on which a connecting part 3 is shaped, for the detachable affixing of the gravity cup on a paint sprayer. Both the tank 1 and the cover 2 with the shaped connecting part 3 are appropriately produced as injection moldings made of plastic. FIG. 2 shows the gravity cup with the cover 2 removed from the tank 1, in a side view. In the position shown in FIG. 2, with the removed cover 2, the cup-shaped tank 1 is filled with a liquid, in particular, a paint, to be sprayed by means of a paint sprayer. Subsequently, the cover 2 is placed on the upper rim of the tank and screwed with the tank via a quick-connect thread. Then, the gravity cup can be inserted, with the connecting part 3 shaped on the cover 2, into the connecting opening of a paint sprayer placed on its head. For the spraying, the paint sprayer can then be turned around, so that the gravity cup is on the upper side of the paint sprayer. In order to make possible a venting of the gravity cup, a venting valve, which is not depicted here, is provided, which is appropriately located on the bottom 4 of the tank 1 and is designed in such a way that it can be closed. The venting valve, which can again be closed after use, offers the advantage that the gravity cup can also be used to store paint which has not been completely used up.

The connecting part 3 consists of a tubular connecting piece 5, which is injected on the conical cover or is shaped in some other way and which comprises a front hollow-cylindrical guide area 6, an external thread 7, which follows, for screwing into a conventional internal thread, and a screw wedge element 8, which follows the external thread 7, for a quick connection of the gravity cup with the paint sprayer.

For the tight connection of the tank 1 and the cover 2, a four-turn quick-connect thread with external thread turns 18, 18′, shaped on the upper external circumference of the tank 1, and corresponding internal thread turns 19, are provided on the cover 2, as can be seen from FIG. 2. The four external thread turns 18, 18′ are located, uniformly distributed over the external circumference, on the upper rim of the tank 1. Each external thread turn 18, 18′ is formed by a plurality of thread segments 18a, 18b, . . . , 18e, 18f, . . . , 18j, arranged along the slope line 10 of the individual external thread turn 18, 18′, wherein a gap 18p, 18q, 18r, . . . is formed. Each external thread turn 18, 18′ has at least two thread segments 18a, 18b, and preferably between four and 10 thread segments. In the embodiment example, shown graphically in FIG. 2, 9 thread segments 18a, 18b, . . . , 18e, 18f, . . . , 18j are provided per external thread turn 18, 18′.

Each external thread turn 18, 18′ has a guide ramp 16. The guide ramp 16 is located on the upper border of two adjacent thread segments 18e, 18f of the external thread turn 18, 18′, as shown in FIG. 5. The guide ramp 16 thereby bridges the two adjacent thread segments 18e, 18f.

The internal thread turns 19 are located on the inside of a flange 11 on the cover 2 (FIG. 3). Each internal thread turn 19 is limited by a first crosslink 12 and a second crosslink 13. The crosslinks 12, 13 are on the inside surface of the flange 11 and run, at an incline with a slope angle corresponding to the slope angle of the external thread turns 18, 18′, on the inside circumference of the flange over a limited angle range. The number of crosslink pairs 12, 13, limiting an internal thread turn, corresponds to the number of the external thread turns 18, 18′. In the graphically depicted embodiment example, four external thread turns 18, 18′ and correspondingly, four internal thread turns 19, are provided. In this embodiment example, the crosslinks 12, 13 then run, over approximately 150°, on the inside circumference of flange 11, wherein the beginnings and the ends of the crosslinks 12, 13 are located, staggered by approximately 90°, with respect to one another, and the first crosslink 13 first forms the lower crosslink of the one internal thread turn and then goes over to the upper crosslink 12 of the adjacent internal thread turn. In the connecting direction of the quick-connect thread, the crosslinks 12, 13 run smoothly toward one another, so that the width of each internal thread turn 19 tapers slightly in the axial direction

On the upper rim of the tank 1, a rim flange 9, thickened in comparison to the tank wall 1a, is provided. The four external thread turns 18, 18′ are preferably located on this rim flange 9, in such a way that the end 20 of the one thread turn 18 lies directly above the beginning 21 of the next thread turn, as shown in FIG. 6. The distance between the end 20 of the one thread turn 18 and the beginning 21 of the next thread turn 18′ is, for example, 4-6 mm. The quick-connect thread is preferably designed as a pitch thread with a slope of, for example, 20 mm. In this way, the cover 2 can be screwed firmly with the tank 1 by, more or less, one-fourth of a rotation. As can be seen from FIG. 7, the thread in the embodiment shown is also designed as a trapezoidal thread with a flank angle of approximately 30°. The quick-connect thread, however, can also be designed as a round thread, a sharp thread, or with another suitable profile. In the preferred embodiment, the outside diameter of the external thread is between 100 and 110 mm, preferably and approximately 105 mm, and the core diameter D of the external thread is between 90 and 105 mm, preferably and approximately 102 mm. The width b of the thread turns on the outside is between 1.1 and 1.3 mm in this embodiment example.

Upon placing the cover 2 on the tank 1, the lower border of the upper crosslink 12 of the internal thread turns is first on the upper border of the external thread turns 18, 18′. By turning the cover 2, with respect to the tank 1, in the closing direction of the quick-connect thread, the external thread turns 18, 18′ mesh into the internal thread turns 19, wherein the guide ramps 16 serve as a guide and prevent tilting. With a further turning of the cover, the guide ramps 16 mesh into the internal thread turns 19 and are clamped there—as a result of the tapering width of the internal thread turns—between the upper crosslink 12 and the lower crosslink 13. The lower border of the two thread segments 18e, 18f, over which the guide ramp 16 is located, thereby form the counterbearing on the upper border of the lower crosslink 13.

Furthermore, an all-round wedge-shaped sealing crosslink 22, shown in FIG. 5, is shaped on the inside of the cover 2; it limits a wedge-shaped, annular groove 23 for the holding of the upper tank rim 24 between its outside and the inside of the cover. By means of the constricting annular groove 23, wedge-shaped upwards in FIG. 5, the upper tank rim 24 is pressed toward the outside on the inside wall of the cover flange 12 when the cover 2 is screwed on, wherein a tightly closing connection is brought about. The sealing crosslink 22 has a sufficiently great height so as to capture paint still remaining in the cover when the cover is placed and to prevent overflowing into the internal thread.

The invention is not limited to the previously described embodiment example shown in the drawing. Thus, for example, the number of the external thread turns 18, 18′ and the internal thread turns 29 can be varied. Furthermore, the number of the thread segments of the external thread turns can be selected differently, wherein at least two thread segments are present per external thread turn. The internal thread turns can also be placed on the upper rim of the tank and the external thread turns can be placed on the cover. Moreover, the internal thread turns can also be made in the form of grooves on the inside surface of the flange 11 or on the upper circumference area of the tank. The connection of the cover on the tank, in accordance with the invention, can, for example, also be used with gravity cups in which the connecting piece for the connection of the gravity cup with the paint sprayer is not located on the cover, but rather on the bottom of the tank. Furthermore, in the embodiment in which the connecting piece is shaped on the cover, an insert (liner), which can be folded together, for holding the paint and affixed on the upper rim of the tank, can be placed in the tank.

1. Gravity cup for a paint sprayer with a cup-shaped tank (1) and a cover (2), which can be placed on the tank (1), wherein for the connection of the tank (1) and the cover (2), a multiplex quick-connect thread with at least two external thread turns (18) and internal thread turns (19), acting together with the external thread turns (18), is provided, wherein each external thread turn (18) is formed by a multiple of thread segments (18a, 18b, . . . , 18j), arranged along the slope line of the individual external thread turn, wherein a gap (18p, 18q, . . . 18w) develops between adjacent thread segments.

2. Gravity cup according to claim 1, wherein each external thread turn (18) has at least two thread segments (18a, 18b).

3. Gravity gap according to claims 1, wherein each external thread (18 has between four and 10 thread segments (18a, 18b, . . . 18j).

4. Gravity cup according to claim 1, wherein the external thread turns (18) are shaped on the upper external circumference of the tank (1).

5. Gravity cup according to claim 1, wherein the internal thread turns (19) are arranged on the inside of a flange (11) on the cover (2).

6. Gravity cup according to claim 5, wherein a wedge-shaped sealing crosslink (22) is shaped on the inside of the cover (2), which limits a wedge-shaped annular groove (23) for holding the upper tank rim (24) between its outside and the inside of the flange (25).

7. Gravity cup according to claim 1, wherein a connecting piece (5) for the connecting of the gravity cup with a paint sprayer is shaped on the cover (2).

8. Gravity cup according to claim 7, wherein a quick-alternating connection with a screw wedge element (8) is provided on the connecting piece (5), which acts together with a counter-element on the paint sprayer for a quick connection of the gravity cup to the paint sprayer.

9. Gravity cup according to claim 1, wherein each external thread turn (18) has at least one guide ramp (16).

10. Gravity cup according to claim 9, wherein the guide ramp (16) is located on the upper side of two adjacent thread segments (18e, 18f) and bridges these two thread segments (18e, 18f).

11. Gravity cup according to claim 1, wherein the quick-connect thread comprises four external thread turns (18), which are arranged, uniformly distributed, over the upper external circumference of the tank (1).

12. Gravity cup according to claim 1, wherein the external thread turns (18) have a trapezoidal shape in the cross-section.

13. Gravity cup according to claim 1, wherein internal thread turns (19), in the direction of closing of the quick-connect thread, taper in the axial direction.

14. Gravity cup according to claim 1, wherein a rim flange (9), thickened in comparison to the tank wall (1a), is provided on the upper rim of the tank (1).

15. Gravity cup according to claim 14, wherein the thickness of the tank wall (1a) is between 0.2 and 1.5 mm and that the thickness of the rim flange (27) is between 0.4 and 2 mm.
